(19) United States
(12) Patent Application Publication
(10) Pub. No.: US 2026/0109039 A1
(43) Pub. Date: Apr. 23, 2026

(54) PRINTING COATING TO PROTECT IN CORROSIVE ENVIRONMENT

(71) Applicant: INTERNATIONAL BUSINESS MACHINES CORPORATION, Armonk, NY (US)

(72) Inventors: Randy A. Rendahl, Raleigh, NC (US); Sarbajit Kumar Rakshit, Kolkata (IN); Vinod Anandram Valecha, Pune (IN); Carolina Garcia Delgado, Zapopan (MX)

(21) Appl. No.: 18/924,152

(22) Filed: Oct. 23, 2024

(51) Int. Cl. B25J 9/16; B25J 11/00; G16Y 40/10

(52) U.S. Cl. CPC B25J 9/1671; B25J 9/1674; B25J 11/0075; G16Y 40/10

(57) ABSTRACT

A computer-implemented method includes evaluating environmental parameters of an activity area where a robot will operate using sensors and analyzing the robot to identify parts needing a protective coating. A protective coating material and thickness are determined based on the environmental parameters and robot analysis. Robotic motion is simulated with the protective coating to optimize protection and mobility. The protective coating is applied to the robot, using three-dimensional (3D) printing, based on the simulation results.

### BACKGROUND

The present invention generally relates to printed protective coatings and, more particularly, to printed coatings to protect objects or machines in damaging environments.

Robotic systems, e.g., robotic arms, humanoid robots, etc. perform activities in different environments. These environments can be corrosive, radioactive, or damaging in some way. These environments can result is costly repairs or permanent damage to robots so exposed. Protecting robots from damage needs to be achieved without loss of functionality of the robot.

### SUMMARY

In accordance with an embodiment of the present invention, a computer-implemented method includes evaluating environmental parameters of an activity area where a robot will operate using sensors and analyzing the robot to identify parts needing a protective coating. A protective coating material and thickness are determined based on the environmental parameters and robot analysis. Robotic motion is simulated with the protective coating to optimize protection and mobility. The protective coating is applied to the robot, using three-dimensional (3D) printing, based on the simulation results.

In accordance with another embodiment of the present invention, a system includes sensors configured to detect environmental parameters of an activity area. An evaluation program is configured to analyze the environmental parameters and robot design to determine protective coating requirements. A simulation and analysis program is configured to optimize a protective coating design based on robot mobility and environmental protection needs. A three-dimensional (3D) printing system is configured to apply the optimized protective coating to the robot.

In accordance with another embodiment of the present invention, a robot with a 3D printed protective coating includes a body with multiple robot components and a protective coating selectively applied to vulnerable components of the body, wherein the protective coating material and thickness are customized based on environmental threats and component mobility requirements. The protective coating is 3D printed directly onto the robot components.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram showing a system/method for 3D printing a protection coating on a robot or machine, in accordance with an embodiment of the present invention;

FIG. 2 is a schematic block diagram showing a system for evaluating and simulating robot movement and determining a material selection for a protective coating on a robot or machine, in accordance with an embodiment of the present invention;

FIG. 3 is a schematic diagram showing a materials selection database for a protective coating for a robot or machine, in accordance with an embodiment of the present invention;

FIG. 4 is a perspective view of a robot arm showing an evaluation of degrees of freedom and movement showing an impact on materials selection for a protective coating for a robot or machine, in accordance with an embodiment of the present invention;

FIG. 5 is a block diagram showing a computer system for 3D printing a protection coating on a robot or machine, in accordance with an embodiment of the present invention; and

FIG. 6 is a schematic diagram showing a robot with a 3D printed protection coating, in accordance with an embodiment of the present invention.

### DETAILED DESCRIPTION

In accordance with embodiments of the present invention, systems and methods are described that provide a protective coating around components in damaging environments. In an embodiment, a 3D printing-based protective layer is employed, which uses 3D printing technology to create and apply protective layers onto surfaces or objects. A customized protective layer or coating can be printed that can provide different functions, such as, e.g., enhanced durability, corrosion resistance, insulation, aesthetic improvements, etc. One aspect of 3D printing-based protective layer printing includes material selection. Different materials can be employed for the protective layer, depending on the desired properties and application requirements. The materials can include polymers, resins, metals, ceramics, or composites that offer specific characteristics such as strength, flexibility, heat resistance, chemical resistance, and others.

With 3D printing, the protective layer can be designed and customized to fit a specific shape, size, and geometry of the object or surface being protected. This permits for precise and tailored protection and customization. In addition, the protective layer can be deposited layer by layer, following a predetermined design or pattern. A 3D printer can precisely control the placement and formation of each layer, resulting in a cohesive and uniform protective coating. The protective layer can also be designed to provide specific functions based on its application. This can include properties such as impact resistance, UV protection, water resistance, chemical resistance, or heat insulation.

Before applying the protective layer, a surface or object may need to be prepared by cleaning, sanding, or priming to ensure proper adhesion and bonding between the protective layer and the substrate. After the protective layer is applied, post-processing steps such as curing, polishing, or painting may be performed to enhance the final appearance and performance of the protective coating. 3D printing-based protective layer printing offers advantages such as customization, rapid prototyping, and the ability to create complex geometries. The protective coating can be used in a number of industries, including manufacturing, automotive, aerospace, electronics, consumer products, and more, to provide an additional layer of protection and improve the overall functionality and aesthetics of objects or surfaces.

In a particularly useful embodiment, a protective coating can be employed to protect robot components. Robotic systems can be employed in damaging environments and require protection. With the formation of a protective coating, robots need to maintain mobility and degrees of freedom, so, along with protective coating, it is also to be ensured that, after applying a protective coating, the robots should be able to exhibit required movement and functionality.

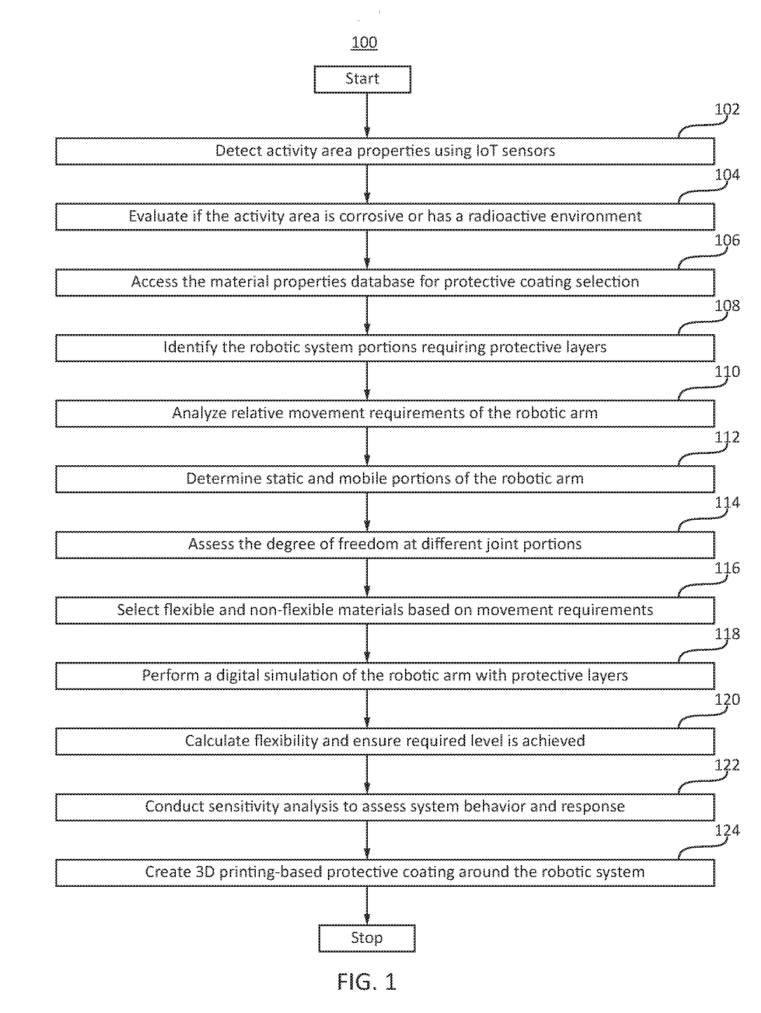

Referring now to the drawings in which like numerals represent the same or similar elements and initially to FIG. 1, systems and methods are described for evaluating an environment and customizing a protective coating to machinery in the environment. In an embodiment, environmental analysis is performed, which analyzes environmental parameters of an activity area where a robot will operate. This can include using systems to detect properties such as corrosiveness or radioactivity of the surrounding environment. A system 100 detects activity area properties using sensors in the environment where the activity will take place in block 102. The sensors can include Internet of things (IoT) sensors or other sensors that can measure chemicals, radiation, radioactivity, smoke, humidity or other environment conditions. In an example, a robot can be placed in a factory environment where corrosive chemicals are present. In block 104, the sensors can evaluate the activity area. For example, the corrosive chemicals can be detected by the sensors, which can measure the corrosive strength of the chemicals and can determine other pertinent details of the environment as they relate to the robots functioning in the factory. Other threats can be identified and evaluated as well.

The system 100 identifies and evaluates environmental parameters around an activity area and duration of activity to be performed by a robotic system so that appropriate materials to be used for a protective coating and an optimum protective coating thickness by 3D printing can be determined.

In block 106, based on the identified threats, a material properties database can be accessed and employed to identify appropriate materials that can be used to counter the one or more threats identified in blocks 102 and 104. The database can include a lookup table or matrix to determine a material or material combination that best protects the robot in the environment. The system 100 can consider the frequency of correcting or replacing protective coatings for the entire tenure of the activity in selecting the material.

In block 108, the robotic system is analyzed to identify which parts need protective coating. The parts that need protective coating will be dependent on a robot design, and its application in the environment. For example, a robot in a corrosive environment will need to have components which may be subject to damage, e.g., exposed metals parts need to be protected while other parts, say, plastic parts can remain exposed. In block 110, an analysis or determination is made as to which parts of the robot need to move and which areas will not. This includes evaluating degrees of freedom for different joints of the robot and assessing vulnerabilities of various components in block 114.

In block 116, material selection is impacted by the flexibility or non-flexibility of parts of the robot. Based on the environmental analysis and robot analysis, the process of selecting appropriate materials for the protective coating can be influenced by the part’s usage and types of motion the part will undergo. This involves consulting the material properties database to choose materials that provide the required protection while maintaining necessary flexibility.

In block 118, a digital simulation of the robotic motion is performed based on its movement requirements with the protective layers modeled thereon. The digital simulation of the robotic system with the protective coating tests different combinations of materials, thicknesses, and coating distributions to optimize protection and mobility of the robot parts.

The simulation can analyze the robotic arm movement, the degrees of freedom of robotic arm movement, joints around the robotic arms where the robotic arms will move, etc., to identify what types of protection layers and materials are to be used around the robotic system so that required protection can be ensured at the same time the robots can exhibit required mobility with the protective layer.

In block 120, based on the simulation results, the final protective coating is determined. This includes determining the optimal thickness, material distribution, and flexibility requirements for different parts of the robot. Based on simulation result, a 3D printed protective coating can be deposited on the robot, the system identifies the level of flexibility of the 3D printed protective layers on different portions of the robot, so that along with 3D printed protective layer, the robotic system can exhibit the relative movement of the arms and can also get required levels of protection from the surrounding.

In block 122, a further check is performed in the form of a sensitivity analysis to assess system behavior and response with the final protective coating. A simulation of the final 3D printed protective coating around the robot can identify additional power requirements (because of increase in self-weight). Difficulties in creating appropriate relative movement of the arms can also be evaluated. Optimum specifications of the 3D printed coating can be identified, and the types of materials that are to be used in different portions of the robotic arms, so that required protection can be applied. The frequency of repairing or re-applying 3D printed coating can also be considered.

In block 124, a 3D printing system is employed to apply the final protective coating onto the robotic system. This can include placing the robot parts or assemblies in a 3D printing environment and printing the protective layer thereon based on an optimized design. An array of 3D printing systems can be employed to proactively coat the robot system using the selected types of materials on different portions of the robot, so that the robot is protected from the harsh environment by a protective 3D printed coating or layer. The robot system can thereby be protected and still be able to perform its activities effectively. In an embodiment, swarm printing can be employed. This can permit a robot or machine that has already been placed or mounted to be customized with protective coatings.

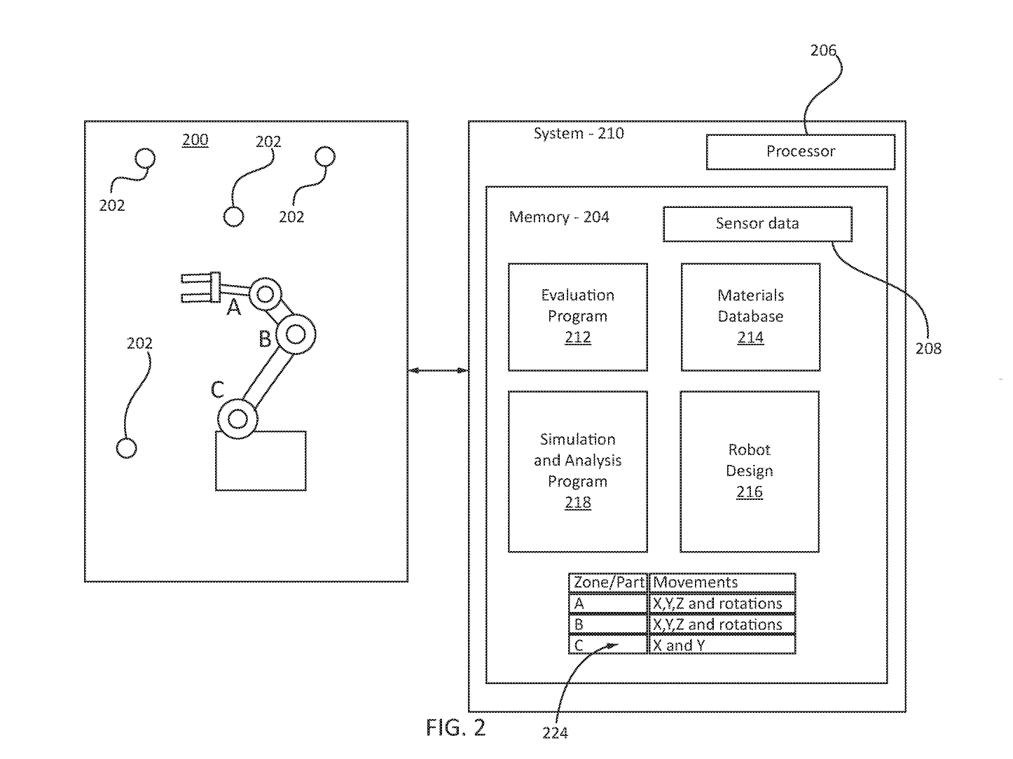

Referring to FIG. 2, embodiments of the present invention can provide customized protection for machinery or robots (hereinafter referred to collectively as a robot 220) in accordance with an operational environment in which the robot 220 will be employed. An illustrative activity area or environment 200 can include a factory, a power plant, a laboratory, an agricultural facility or any other environment where machine or robots can be deployed and potential exposure to damaging materials, e.g., corrosive materials, radioactive materials, humidity/condensation, etc. Sensors 202 can be deployed in the environment 200 permanently or temporarily and can be employed to evaluate the environment 200 in real-time and over a time duration to gain an understanding of the environment 200. In an embodiment, an IoT enabled system can be employed as sensors 202 to detect the properties of the environment 200 and identify whether the environment 200 is corrosive, radioactive, etc. and durations and intensities of such properties.

A computer system 210 includes memory 204 and one or more hardware processors 206. The memory 204 includes storage for sensor data 208 and a number of programs that are employed to implement the present embodiments. Based on the sensors 202 (e.g., IoT feeds) from the environment 200, the system 210 includes an evaluation program 212 that evaluates, e.g., a level of corrosiveness, radioactivity, etc. The IoT feeds can include static devices that are part of the environment or mobile devices including drones, robots, etc. to get a clear understanding of the environment 200. The evaluation program 212 can determine explicit types of chemicals, radiation or other environmental hazards so that targeted protection of the robot 220 or other devices can be deployed in the environment 200. The evaluation program 212 differentiates vulnerable components versus materials not subject to deterioration so that vulnerabilities of parts of the robot 220 or machinery can be determined. Based on the types of corrosive/ radioactive agents the system 210 can also employ historical data to estimate patterns of decay of parts of the robot 220. The system 210 can employ the pattern of decay to associate a level of corrosion with a cost of repairing or re-coating. This feedback can be employed in determining a material selection and coating thickness.

A material properties database 214 includes types of materials, material specifications, availability of materials, protective layer types including combinations of available materials, etc. Since the protective layer will be printed, the material selection needs to be in a printable form, e.g., a filament. The system 210 includes a design file or files on a design architecture of the robot 220. The system 210 can identify which robotic parts need to be protected by protective layers and can identify specific portions of the robot (e.g., a robotic arm, a joint region, a flexible connector, etc.) where relative movement of the robot 220 is needed.

Based on the known hazards, each exposed part of the robot 220 will be evaluated by the evaluation program 212 for susceptibility to degradation (and to which of the hazards). Based on the analysis of the robot 220, the system 210 identifies which portion of the robot 220 will be static, and which portion have a different level of relative movement. Analysis may be based on observed activity in performing the required steps or through a digital twin simulation of the activity. The activity of the robot 220 can be input to the system 210. For example, the degrees of freedom of each joint on different joint portions of the robotic arms, and how much movement is needed can be collected and can be stored in a table or matrix 224. In an embodiment, the matrix 224 includes zones A-C and associated movements, e.g., X, Y, Z translations and /or rotations about these axes.

The movement of portions of the robot 220 is also employed to determine where no relative movement is needed, where non-flexible material can be used, etc. At portions of the robot 220 where relative movement is present, a flexible material can be employed for the protective coating. Consideration of vulnerability of robot components is evaluated to determine if any protection is needed. This permits a much more selective application of protection that reduces cost, weight and movement limitations where unneeded. The system 210 can identify a weight of the additional material used for creating the protective coating on the robot 220 and additional power required for mobility of the robot 220.

For each part of the robot 220, a material for the protective coating can be selected based on the type of hazard that is both present and detrimental to the subject part. The system 210 includes a simulation and analysis program 218 that can generate a digital twin of the robot 220 and has access to design drawings and models of the robot 220 such that a digital simulation of the robot 220 with a proposed protective coating can be performed. In an embodiment, portions of the robot 220 that do not have any relative mobility can be modeled as a static object, and portions having relative movement can be modeled with motion and can employ flexible material for the protective coating.

During the simulation(s) of the robot 220, movement with protective layers is modeled. Flexibility can be calculated in various ways depending on the context and the specific system or scenario being considered. For example, a few methods for calculating a level of flexibility on different joints of robot arms can include simulating motion while varying base materials in the areas of movement (zones), types of filaments that can be used for printing, number of layers (thicknesses), movement results due to the proposed protective layer, etc. The process can be iterative to optimize the protective coating features. The analysis by the simulation and analysis program 218 can be based on combinations of materials, protective layers, thickness, types of layers, etc. and is completed when the movement results are properly executed during the simulation process and other criteria are met. After applying the coating, the robot 220 can lose some degree of relative mobility. A consideration of a tolerance level can be made during the simulation stage to evaluate how much flexibility can be achieved with the available material. The simulation can consider robotic dynamics modeling, and the degrees of freedom required for the robot 220 to perform the activity.

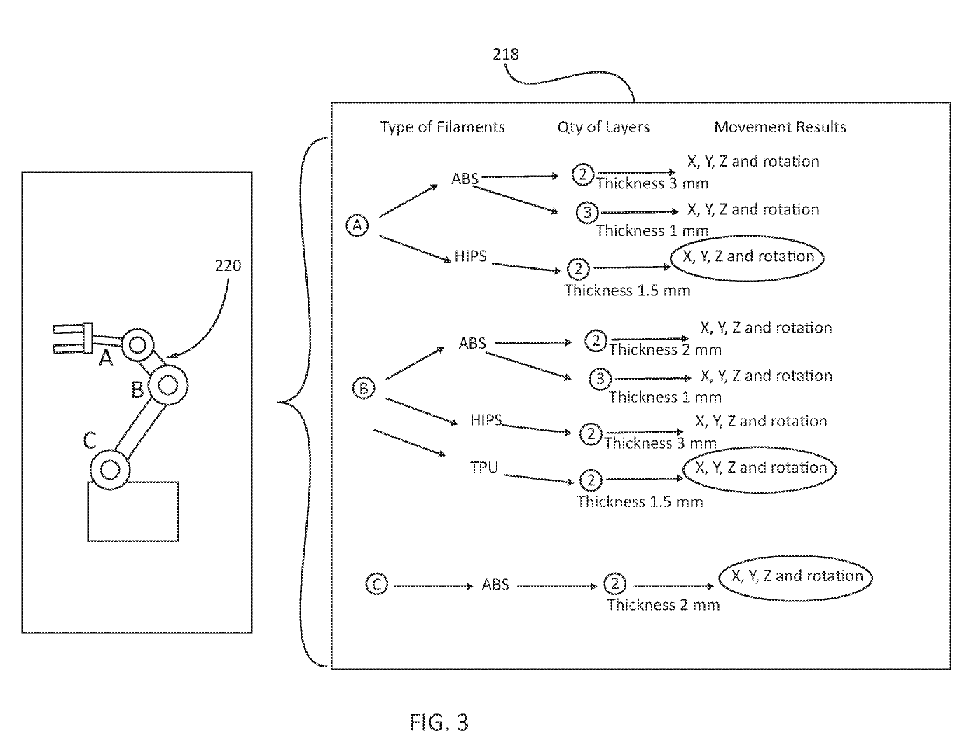

Referring to FIG. 3 with continued reference to FIG. 2, materials are selected through the types of filaments for the printing process for protective coatings. The simulation and analysis program 218 can conduct a simulation to determine the material or printing filaments. During simulation, the system 210 can employ trial and error methods to select different combinations of materials on different portions of the robot 220, and determine an appropriate thickness. In an example, zone A of the robot 220 can be simulated with acrylonitrile butadiene styrene (ABS) filaments and high impact polystyrene (HIPS) filaments. HIPS with two layers (thickness of 1mm) maintains the needed movement results and is therefore selected. The ABS with 2 and 3 layers was too thick and an did not permit the required movements for zone A of the robot 220. Similar simulation analyses can be performed in other zones (e.g., B, C, etc.) using different filaments and combinations to test whether proper movement results are achieved. The result will be coating filaments selected, number of layers, types of layers, thickness, etc. for protective coatings.

The simulation and analysis program 218 can perform similar analyses for including flexibility in certain areas of the robot 220 and placement of the protective coating in certain areas of the robot 220. Flexibility is the inverse of stiffness. For example, consider a spring that has Q and q as, respectively, its force and deformation. The spring stiffness relation is Q = k q where k is the spring stiffness. Its flexibility relation is q = f Q, where f is the spring flexibility. Spring analysis can be employed to determine the type of protective coating to employ in areas where more flexibility is needed. Combinations of materials and combinations of layers of materials can be employed to match spring properties needed to provide flexibility at joints of other features of the robot 220. Based on the selection of material for coating, and also the thickness of the coating material, the stiffness will be changed, so the system 210 needs to check the desired level of robotic arm movement that can be achieved with the coating, and if the same is within a threshold limit.

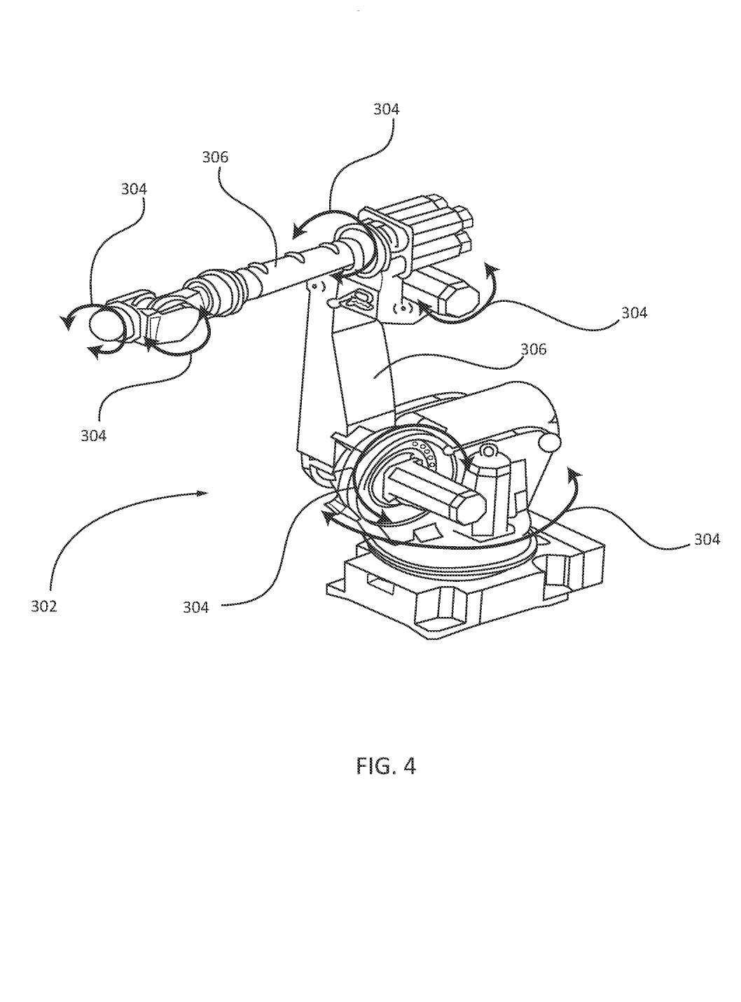

Referring to FIG. 4, an illustrative robot arm 302 is shown to which a protective coating is to be applied. The robot arm 302 includes six rotational axes 304 and connector arms 306, which can be considered static objects (not flexible). As part of the analysis of the simulation and analysis program 218, degrees of freedom of the robot features are determined. A 3D model can be employed around the robot 220 and used to select which portion of the robot will receive which types of material for the protective coating. The impact of the damaging environment is considered for the robot features. In this example, the six rotational axes 304 will need some flexibility in the coating material selected. With trial and error or the use of artificial intelligence inferencing, an optimal protective coating thickness with flexibility can be determined to achieve required motion for the robot arm 302. The protective coating can be designed to move with the robot 220.

Some regions of the robot 220 will not need a protective coating and others will. The system 210 can determine locations where the protective coating can be omitted. In this way, printing materials and time can be spared, as well as reducing an overall weight by reducing the amount of protective coating.

Based on the material properties, a sensitivity analysis can be performed. The sensitivity analysis includes a method used to measure the impact of changes in certain variables or parameters on the overall system performance or outcome. The sensitivity analysis can be performed using the simulation and analysis program 218 (FIG. 2). The sensitivity analysis helps assess how variations in specific factors influence the robot system’s behavior, output, and/or response. Sensitivity analysis can be conducted through numerical simulations, statistical techniques, or other analytical methods.

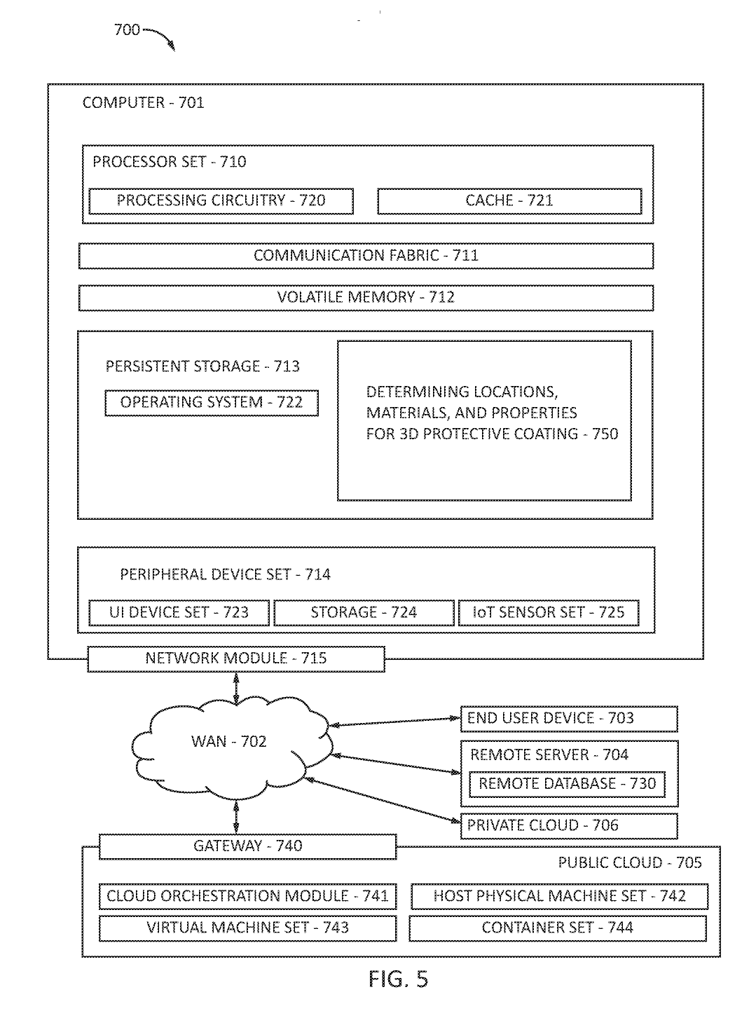

Referring to FIG. 5, a computing environment 700 contains an example of an environment for the execution of at least some of the computer code involved in performing the inventive methods, such as determining locations, materials and properties of a 3D protective coating for harsh environments 750. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes a remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 401, to keep the presentation as simple as possible. Computer 701 may be located in a cloud, even though it is not shown in a cloud in FIG. 5. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 401 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715. WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

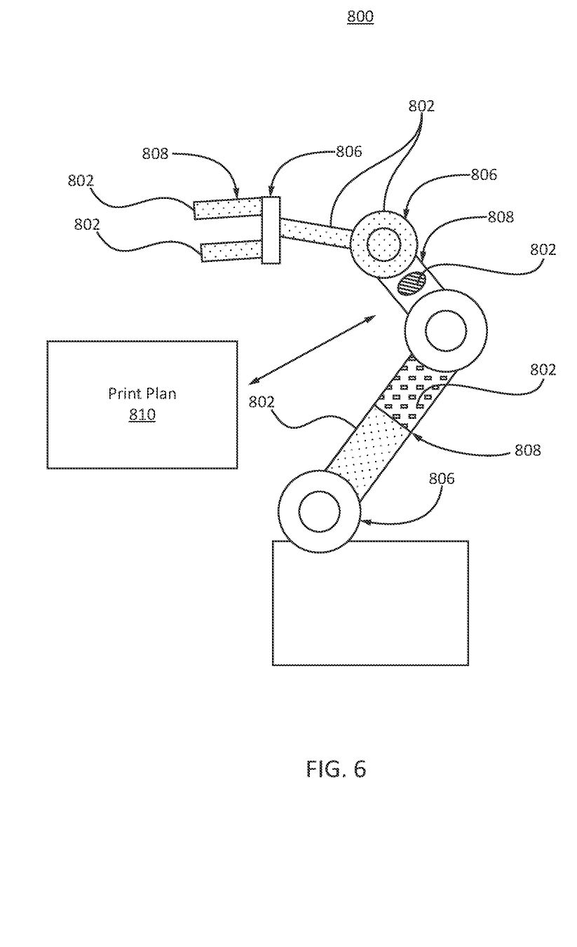

Referring to FIG. 6, a protective coating 802 is printed on a robot 800 in accordance with a digital print plan 810 resulting from the analysis carried out by the system 210. Individual parts or subassemblies of the robot 800 can be mounted within a printing device or swarm 3D printing can be employed.

Swarm 3D printing or cooperative 3D printing or swarm manufacturing employs a swarm of mobile robots with different functionalities to work together to print the protective coatings on a machine or robot in accordance with the digital print plan 810. The digital print plan 810 is based on geometry and functionality of components of the robot 800 and includes materials and thicknesses for the protective coating over the robot 800. Different regions of the robot 800 can be handled by different print robots in the swarm, which are then assigned specialized tasks for printing. The swarm robots can move freely about the robot 800 and can employ different capabilities, print filaments, filament extruders, printheads, etc. The swarm 3D printing system prints a 3D printing-based protective coating around the robot 800 in accordance with the present embodiments.

The robot 800 includes a body 804 with multiple components including flexible joints 806 and rigid members 808. The robot 800 can include sensors integrated into the body to detect environmental parameters, robot motion or other measurable parameters. The protective coating 802 is selectively applied to vulnerable components of the body 804. The protective coating material and thickness are customized based on environmental threats and component mobility requirements and can be placed on portions of the flexible joints 806 and rigid members 808 or the entirety of the flexible joints 806 and rigid members 808. The protective coating 802 is 3D printed directly onto the robot components and can be customized using different materials on different areas and portions of the robot 800.

The protective coating 802 can include different materials and thicknesses applied to different components based on their vulnerability to environmental threats and mobility requirements. The flexible materials can be applied to the components, e.g., the flexible joints 806, requiring movement, and rigid materials can be applied to static components, e.g., rigid members 808. The flexible materials can include, e.g., polymers or elastomers, and the rigid materials can include, e.g., ceramics or composites. The protective coating 802 can include multiple layers of different materials to provide enhanced protection against multiple environmental threats. In an example, a robot arm can include a first protective coating on a first portion and includes a different protective coating on a second portion of the same arm. The arm can further include flexible coatings on the joints and include a combination of layers of protective coating on a yet another portion. The robot protection can be highly customized

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
evaluating environmental parameters of an activity area where a robot will operate using sensors;
analyzing the robot to identify parts needing a protective coating;
determining a protective coating material and thickness based on the environmental parameters and robot analysis;
simulating robotic motion with the protective coating to optimize protection and mobility; and
applying the protective coating to the robot, using three-dimensional (3D) printing, based on simulation results.

2. The method of claim 1, wherein evaluating environmental parameters comprises using Internet of Things (IoT) sensors to detect properties of the activity area.

3. The method of claim 1, wherein analyzing the robot comprises evaluating degrees of freedom for different joints of the robot and assessing component vulnerabilities.

4. The method of claim 1, wherein determining the protective coating material and thickness comprises accessing a material properties database to identify appropriate materials to counter identified environmental threats.

5. The method of claim 4, wherein the material properties database includes types of materials, material specifications, and protective coating types including combinations of available materials.

6. The method of claim 1, wherein simulating robotic motion comprises performing a digital simulation of the robot with the protective coating to test combinations of materials, thicknesses, and coating distributions.

7. The method of claim 1, wherein applying the protective coating comprises using a swarm of mobile 3D printing robots to cooperatively print the protective coating on the robot.

8. A system, comprising:
sensors to detect environmental parameters of an activity area;
an evaluation program to analyze the environmental parameters and robot design to determine qualities of a protective coating;
a simulation and analysis program to optimize the qualities of the protective coating for a protective coating design based on robot mobility and environmental protection needs; and
a three-dimensional (3D) printing system to apply the protective coating to a robot.

9. The system of claim 8, wherein the sensors comprise Internet of Things (IoT) sensors to detect conditions in the activity area.

10. The system of claim 8, wherein the evaluation program differentiates between vulnerable and non-vulnerable components of the robot design to determine selective application of the protective coating.

11. The system of claim 8, further comprising a material properties database including types of materials, material specifications, and protective coating types, wherein the evaluation program is configured to access the material properties database to select appropriate materials for the protective coating.

12. The system of claim 11, wherein the simulation and analysis program conducts simulations using combinations of materials and thicknesses from the material properties database to optimize the protective coating.

13. The system of claim 12, wherein the simulation and analysis program performs a sensitivity analysis to assess system behavior and response with the protective coating.

14. The system of claim 8, wherein the 3D printing system comprises a swarm of mobile 3D printing robots to cooperatively print the protective coating on a robot according to a digital print plan generated by the simulation and analysis program.

15. A robot with a three dimensional (3D) printed protective coating, comprising:
a body with multiple robot components;
a protective coating selectively applied to vulnerable components of the body, wherein a material of the protective coating and thickness are customized based on environmental threats and component mobility requirements; and
wherein the protective coating is 3D printed directly onto the robot components.

16. The robot of claim 15, wherein the protective coating is non-uniformly applied over the robot.

17. The robot of claim 15, wherein the protective coating comprises different materials and thicknesses applied to different components based on their vulnerability to environmental threats and mobility requirements.

18. The robot of claim 17, wherein flexible materials are applied to components that move and rigid materials are applied to static components.

19. The robot of claim 18, wherein the flexible materials comprise polymers or elastomers and the rigid materials comprise ceramics or composites.

20. The robot of claim 19, wherein the protective coating further comprises multiple layers of different materials to provide enhanced protection against multiple environmental threats.
